(19) United States
(12) Patent Application Publication
(10) Pub. No.: US 2022/0168812 A1
(43) Pub. Date: Jun. 2, 2022

(54) Z-AXIS MEASUREMENT AND CONTROL IN 3D PRINTING OF METAL

(71) Applicant: Desktop Metal, Inc., Burlington, MA (US)

(72) Inventor: Mark Gardner Gibson, Carlisle, MA (US)

(73) Assignee: Desktop Metal, Inc., Burlington, MA (US)

(21) Appl. No.: 17/437,402

(22) PCT Filed: Mar. 20, 2020
(86) PCT No.: PCT/US2020/023945

§ 371 Date: Sep. 8, 2021

Related U.S. Application Data
(60) Provisional application No. 62/829,324, filed on Apr. 4, 2019.
(60) Provisional application No. 62/822,092, filed on Mar. 22, 2019.
(60) Provisional application No. 62/822,107, filed on Mar. 22, 2019.
(60) Provisional application No. 62/822,120, filed on Mar. 22, 2019.

(51) Int. Cl. B22F 10/31; B22F 10/22; B22F 12/90; B22F 10/80; B33Y 40/00; B33Y 30/00; B22F 12/53

(52) U.S. Cl. CPC B22F 10/31; B22F 10/22; B22F 12/90; B33Y 50/00; B33Y 40/00; B33Y 30/00; B22F 12/53; B22F 10/80

(57) ABSTRACT

Disclosed is the measurement and control of height in the Z-axis of layers produced in an additive manufacturing process. The height of layers being deposited can be monitored, which may involve the use of a fiducial tower to measure a global errors or optical or other means to measure layers on a layer-by-layer basis. Droplet size, pitch and other conditions may be modified to ameliorate or correct detected errors.

### FIELD OF THE DISCLOSURE

The subject matter of the present disclosure generally relates to controlling layer height during additive manufacturing, and more particularly relates to monitoring, controlling and correcting layer height in the Z-axis direction during deposition of successive layers of build material.

### BACKGROUND OF THE DISCLOSURE

In jetting-based metal 3D printing, 3D shapes are created by jetting liquid metal onto a substrate. Frequently the metal is jetted downward and the part is thus built upward in layers. The height of each layer is roughly determined by the nature of the metal being deposited (for example, the surface tension of the material), as well as the rate of metal deposition relative to the linear movement of the substrate. For drop-on-demand printing, the drop size and the distance between deposited drops will affect the resultant layer height. Interactions with previously-printed material (for example, printing immediately adjacent to previously printed material on the same layer) can also affect the resultant height of a printed line. In fact, printing multiple lines closer together creates taller layers than when the lines are spaced farther apart, even when the drop size and pitch are held constant.

The height of the printed part may diverge from that intended due to uncontrolled variations in the printing process. The application rate of the jetted metal may be impactful—for example, variations in drop size, extra “satellite” droplets, or, in the case of ejecting a continuous stream of metal vs. individual drops, variations in the flow rate of jetted metal stream. Geometric conditions, such as the use of partial-density infill, sharp corners, overhangs, etc. may also result in undesired variations in height. Variability of the mechanical systems moving the part relative to the printhead may also result in such deviations. Such height variations may be local, with different areas of a part or layer having different heights, and/or global, where entire layers or the entire part is effectively scaled up or down in height. All of these conditions are considered inaccuracies and are undesirable in 3D printed parts. It is desirable to prevent these conditions whenever possible, and when not possible, to identify and measure these conditions and take corrective actions to ameliorate the error. Corrective action may include, intentionally printing subsequent layers or portions of layers taller or shorter than nominal (for example by altering drop size and/or spacing), jetting additional material into “low” areas, and/or removing excess material from “high spots” on the top surface of the part.

In most ink-jet or droplet-jetting print systems, the head or substrate is moved in a single axis, and the image (for 2D) or layer of a solid part (for 3D) is created by so-called ‘rastering’—that is, the image or layer is divided into a grid, and those points on the grid where image/layer occur are jetted onto. If the droplet size is small enough, high-quality high-resolution images or parts can be created using this method.

In the case of metal drop-on-demand 3D printing, the material deposition rate is proportional to the cube of droplet radius and the frequency of jetting. Achieving a commercially-viable deposition rate (which enables reasonable part print times) requires either large droplets, or high jetting frequencies, the latter of which can cause other problems such as nozzle resonance or excessive power consumption. Because of the cube relationship to drop size, massive gains in deposition rate can be achieved by relatively small increases in drop size. However, with larger drop sizes (often orders of magnitude larger than typical aqueous ink-jet drops), printing parts via the aforementioned rastering technique requires a relatively coarse grid, which produces visible artifacts in the printed parts and limits the minimum feature size which can be created.

To avoid this problem, it is desirable to print using so-called ‘vector paths’, in which the grid is not used. Instead, the boundaries (known by those skilled in the art as ‘inner and outer walls’) of the layer are traced directly by the motion system, with accuracy and resolution limited only by the original tessellated model and the motion system employed (so long as the paths do not self-intersect). In some implementations, the printed area between the walls (known as ‘infill’) is printed in a semi-raster fashion, with evenly-spaced printed lines of material filling the area between walls, but the drops not falling on any specific grid.

Currently, vector paths are commonly used in the 3D printing technology known as FFF. Software commonly known as ‘slicer software’ divides a 3D model (often in tessellated format such as .STL) into layers, and plans a plurality of “toolpaths” or “paths” to deposit beads of material into thin layers, a plurality of which are stacked to create the desired parts. The toolpaths are output in the form of “G-code” (again originally used in CNC machine tools), which FFF printers are designed to process directly. There are several well-established slicer software programs available as open-source software, such as ‘Cura’ and Slic3e, and the free availability and maturity of these offerings makes them attractive for use in printing processes other than that for which they were originally intended.

Because FFF printers trace the outlines of the printed parts, and users can be reasonably expected to print parts of any shape and size that fits within the printer's build envelope, the paths the printers deposit can be of any length. For example the length of a path tracing the outside of a circular part must be exactly the circumference of the part (or an fixed offset from it). Assuming a constant deposition width (which is true for most if not all slicer software), and desiring a consistent path height, it follows that the volume of material deposited in a toolpath can be essentially any amount. This is easily accommodated by the fine resolution of the stepper motors commonly used in FFF extruders.

By contrast, in drop-on-demand printing, the ink or metal is delivered in discrete quantities, namely the volume of a single drop. As a result, when printing an FFF toolpath using drop-on-demand ink-jet printing, and assuming the drops are deposited in an evenly-spaced manner (i.e. at a fixed drop pitch) in order to produce consistent layer heights, the only paths which can be accurately jetted are those whose lengths are an integer multiple of the drop pitch. For drops of sufficiently-small size, the drop-pitch would be small enough that the quantizing effect would be negligible. However, as described above, in metal drop-on-demand printing it is desirable to use larger droplets in order to achieve commercially-viable build rates. At the resulting drop-pitches, path lengths have appreciable discretization. This creates a contradiction with the requirement that FFF paths be any length. To use FFF toolpaths with drop-on-demand printing without creating height errors, this contradiction must be resolved.

There is another class of problem associated with executing FFF toolpaths with a drop-on-demand printer, which is that of programming a motion controller or other motion-generating system to deposit the droplets in the correct locations along the FFF toolpath. An obvious approach would be to jet droplets at a constant frequency while moving the jetting head. However, any variation in the head speed (for example, to accelerate from or decelerate to a stop, or to slow for a sharp corner), would create changes in the spacing between droplets as the speed changed, which would create height variations.

Another approach would be to jet droplets at a constant rate as a function of distance moved by the printhead relative to the part being printed, similar to the approach used in raster printing, but in two dimensional head movement. However, in vector printing there are conditions (for example, acute angled corners where the path overlaps itself) where the material deposition rate must be altered, and failing to do so would create a buildup of excess material or a ‘low spot’ where not enough material were deposited. The slicer software is recognizes these geometric conditions and can adjust the material output accordingly, but to take advantage of this, a drop-based printer must be able to respond to these commands from the slicer.

Another approach would be to individually command the position of each drop. In this case, a G-code file or other list of motion commands would need a positioning command for each droplet—if the jetting frequency were 1 kHz, the motion controller would need to interpret positioning commands at this rate, which is not feasible for most commercial controllers. In addition, the file size required to describe the position of each of the hundreds of thousands or even millions of droplets in a large part could be prohibitive.

Therefore, a method is needed by which motion commands can be efficiently communicated to the printer control system while ensuring that individual drops are placed correctly, in order to produce consistent layer heights.

Another issue which must be addressed is the delay between the time a drop command is issued, and the time the drop lands on the substrate. This delay consists of several portions—the time to prepare the nozzle to eject a drop, the time to actually eject the drop, and the flight time from the nozzle to the substrate. In practical systems, this time can approach 10 ms, during which time the head and table would have moved away from the intended drop landing position, resulting in drop placement error. While this delay is constant in time, the size of the resulting error (in distance from desired to actual drop position) will vary with the relative velocity of the head and substrate, and the distance between them.

In systems where the head is stationary and the part is moving, this error will be along the path being printed. However, an additional issue arises in systems in which the head (and not the part being printed) is moving. In such systems, the released droplet will have a horizontal component in the direction of the head at the moment of release. If the intended landing position of the droplet is not along this vector, the drop will land off the intended path.

### SUMMARY

Disclosed are methods and systems for the prevention, measurement and amelioration of errors that may occur during additive manufacturing.

Disclosed are several measuring methods that may be employed to determine the Z-axis error of addictively manufactured parts.

In a first embodiment, a fiducial tower is simultaneously manufactured with the part, and is measured in height to determine in overall average error by comparing the actual height obtained with the intended height.

In a second embodiment, the uppermost surface of the part being manufactured is measured for height by a sensor, either during deposition of the layer or after deposition of the layer and before the deposition of the subsequent layer. Sensors and techniques that can be used for the is determination include: a laser point scanner, scanned across the part surface; a laser line scanner; a camera with auto-focus, wherein the camera reports the distance at a point and the part is scanned with the camera; a camera with a fixed focus, wherein computer vision software uses the degree of blur to estimate distance; a camera with a motorized focus swept through a range, wherein computer vision software makes a map of the entire field of view; a camera with a fixed focus, wherein the uppermost surface is sweep through a focus range; and a camera looking across the top surface focused at a specific distance while printing. These sensor setups are discussed in greater detail below.

In other embodiments, the distance between droplets (pitch) is adjusted so that the first and last droplets are properly laid at their intended locations.

In other embodiments, droplet size and/or pitch are adjusted to ameliorate or correct local or global errors in parts undergoing manufacture.

### BRIEF DESCRIPTION OF THE DRAWINGS

The foregoing summary, preferred embodiments, and other aspects of the present disclosure will be best understood with reference to a detailed description of specific embodiments, which follows, when read in conjunction with the accompanying drawings, in which:

FIG. 1 is a block diagram of an additive manufacturing system for magnetohydrodynamic molten metal printing.

FIGS. 2A-C are depictions of the nozzle of the system of FIG. 1.

FIG. 3 depicts a side view of an additive manufacturing process.

FIG. 4 depicts examples of errors that may occur during an additive manufacturing process.

FIG. 5 depicts an embodiment in which a fiducial tower is manufactured alongside the part being manufactured.

FIG. 6 depicts an embodiment in which the surface of a part being manufactured is optically analyzed.

FIG. 7 depicts an embodiment in which the surface of a part being manufactured is analyzed via a laser.

FIG. 8 depicts the changing profile of deposited medium according to drop pitch and speed.

FIGS. 9A-B depict problematic conditions that can occur during printing depending on the chosen tool pathing.

FIG. 10 depicts droplet place with respect to the tool path during construction of various segments.

FIG. 11 depicts a theoretical FFF deposition.

FIG. 12 depicts the effects of drops jetted along an FFF toolpath without position compensation

FIG. 13 depicts the effects of corner bunching, when a drop is not placed exactly at a corner and drops overlap as a result.

FIG. 14 depicts the same path printed with a drop placed exactly at the corner, preventing the overlap.

### DETAILED DESCRIPTION

Disclosed are methods and systems for measuring, controlling and correcting z-axis height in layers deposited during additive manufacturing.

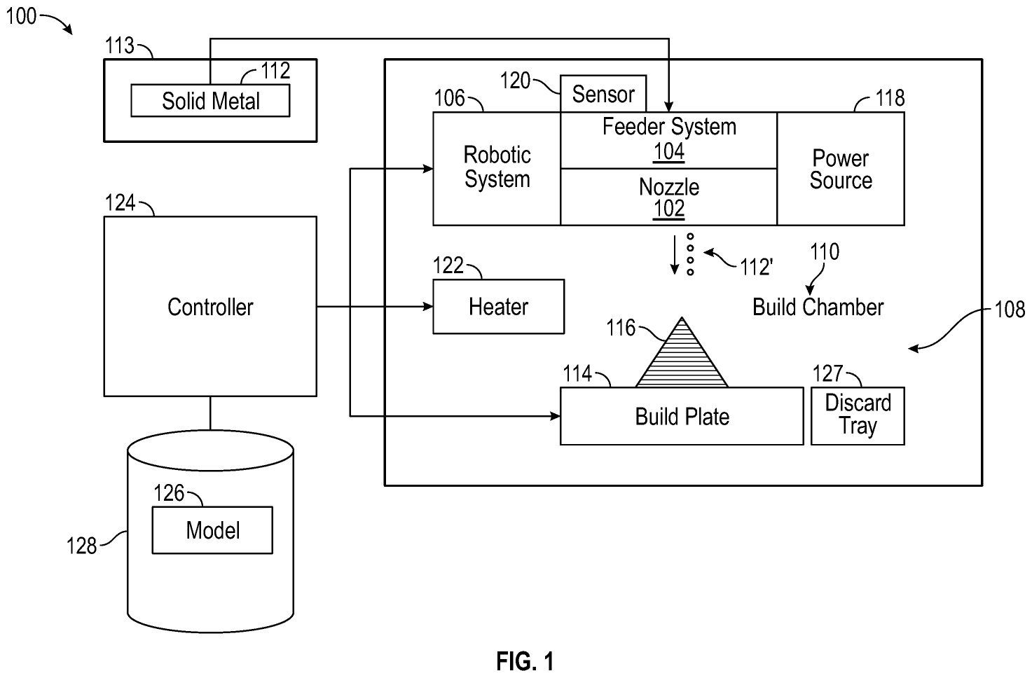

Disclosed now is a non-limiting example of an additive manufacturing technology with which the present disclosure may be employed. It should be understood that other additive manufacturing technologies may be employed. The now described method of additive manufacturing is detailed as context for understanding the remaining disclosure. FIG. 1 is a schematic depiction of an additive manufacturing system 100 using MHD printing of liquid metal 100 in which the disclosed improvements may be employed. Additive manufacturing system 100 can include a nozzle 102, a feeder system 104, and a robotic system 106. In general, the robotic system 106 can move the nozzle 102 along a controlled pattern within a working volume 108 of a build chamber 110 as the feeder system 104 moves a solid metal 112 from a metal supply 113 and into the nozzle 102. As described in greater detail below, the solid metal 112 can be melted via heater 122 in or adjacent to the nozzle 102 to form a liquid metal 112′ and, through a combination of a magnetic field and an electric current acting on the liquid metal 112′ in the nozzle 102, MEM forces can eject the liquid metal 112′ from the nozzle 102 in a direction toward a build plate 114 disposed within the build chamber 110. Through repeated ejection of the liquid metal 112′ as the nozzle 102 moves along the controlled pattern, an object 116 (e.g., a two-dimensional object or a three-dimensional object) can be formed. The object may be formed based on a model 126 enacted through a controller 124. In certain embodiments, the object 116 can be moved under the nozzle 102 (e.g., as the nozzle 102 remains stationary). For example, in instances in which the controlled pattern is a three-dimensional pattern, the liquid metal 112′ can be ejected from the nozzle 102 in successive layers to form the object 116 through additive manufacturing. Thus, in general, the feeder system 104 can continuously, or substantially continuously, provide build material to the nozzle 102 as the nozzle 102 ejects the liquid metal 112′, which can facilitate the use of the three-dimensional printer 100 in a variety of manufacturing applications, including high volume manufacturing of metal parts. As also described in greater detail below, MHD forces can be controlled in the nozzle 102 to provide drop-on-demand delivery of the liquid metal 112′ at rates ranging from about one liquid metal drop per hour to thousands of liquid metal drops per second and, in certain instances, to deliver a substantially continuous stream of the liquid metal 112′. A sensor or sensors 120 may monitor the printing process as discussed further below.

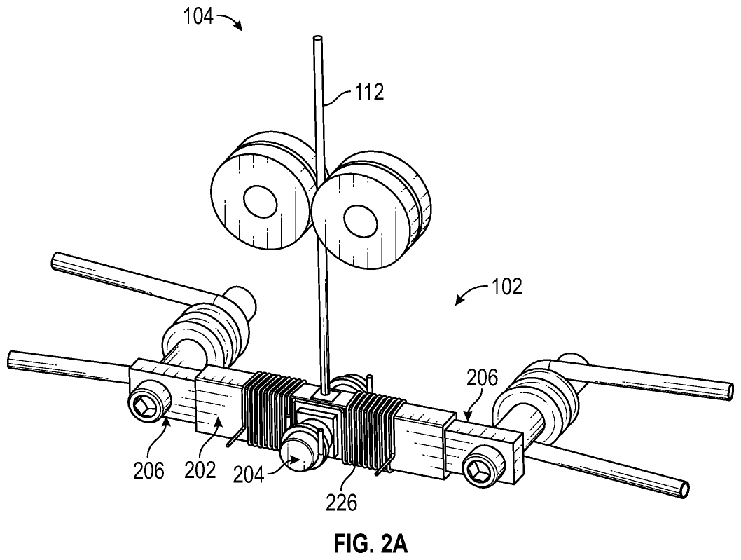

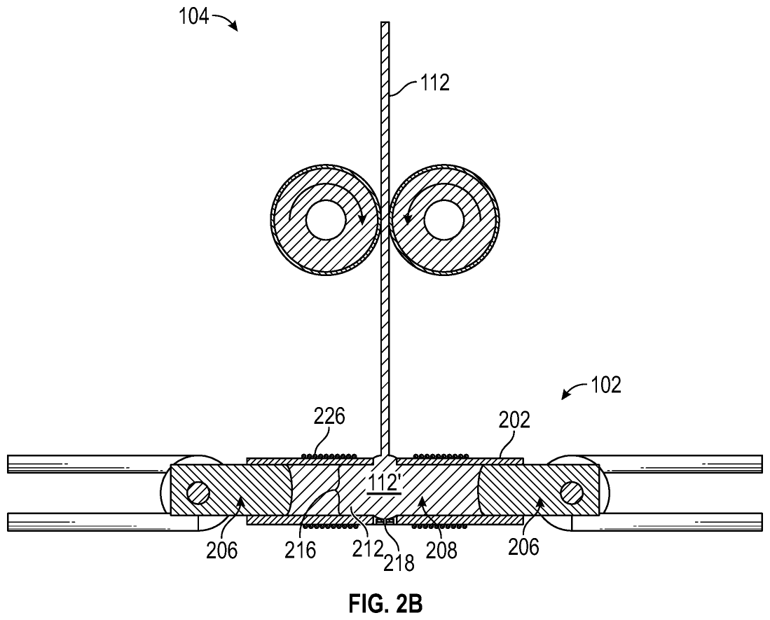

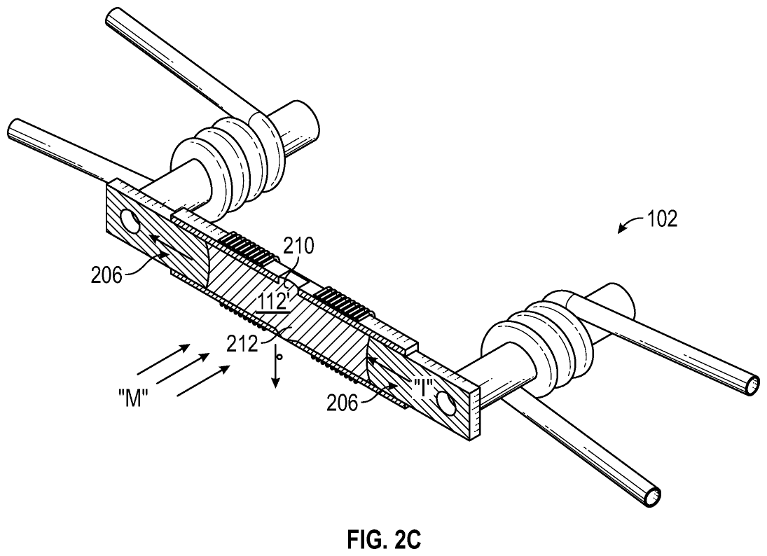

Now with reference to FIGS. 2A-D which depict the nozzle of the printer of FIG. 1. The nozzle can include a housing 202, one or more magnets 204, and electrodes 206. The housing 202 can define at least a portion of a fluid chamber 208 having an inlet region 210 and a discharge region 212. The one or more magnets 204 can be supported on the housing 202 or otherwise in a fixed position relative to the housing 202 with a magnetic field “M” generated by the one or more magnets 204 directed through the housing 202. In particular, the magnetic field can be directed through the housing 202 in a direction intersecting the liquid metal 112′ as the liquid metal 112′ moves from the inlet region 210 to the discharge region 212. Also, or instead, the electrodes 206 can be supported on the housing 202 to define at least a portion of a firing chamber 216 within the fluid chamber 208, between the inlet region 210 and the discharge region 212. In use, the feeder system 104 can engage the solid metal 112 and, additionally or alternatively, can direct the solid metal 112 into the inlet region 210 of the fluid chamber 208 as the liquid metal 112′ is ejected through the discharge orifice 218 through MHD forces generated using the one or more magnets 204 and the electrodes 206. A heater 226 may be employed to heat the housing 202 and the fluid chamber 208 to melt the solid metal 112. A discard tray 127 is located in proximity to the build plate and the nozzle may deposit droplets in it during a testing or calibration step.

In certain implementations, an electric power source 118 can be in electrical communication with the electrodes 206 and can be controlled to produce an electric current “I” flowing between the electrodes 206. In particular, the electric current “I” can intersect the magnetic field “M” in the liquid metal 112′ in the firing chamber 216. It should be understood that the result of this intersection is an MHD force (also known as a Lorentz force) on the liquid metal 112′ at the intersection of the magnetic field “M” and the electric current “I”. Because the direction of the MHD force obeys the right-hand rule, the one or more magnets 204 and the electrodes 206 can be oriented relative to one another to exert the MHD force on the liquid metal 112′ in a predictable direction, such as a direction that can move the liquid metal 112′ toward the discharge region 212. The MHD force on the liquid metal 112′ is of the type known as a body force, as it acts in a distributed manner on the liquid metal 112′ wherever both the electric current “I” is flowing and the magnetic field “M” is present. The aggregation of this body force creates a pressure which can lead to ejection of the liquid metal 112′. It should be appreciated that orienting the magnetic field “M” and the electric current substantially perpendicular to one another and substantially perpendicular to a direction of travel of the liquid metal 112′ from the inlet region 210 to the discharge region 212 can result in the most efficient use of the electric current “I” to eject the liquid metal 112′ through the use of MHD force.

In use, the electrical power source 118 can be controlled to pulse the electric current “I” flowing between the electrodes 206. The pulsation can produce a corresponding pulsation in the MHD force applied to the liquid metal 112′ in the firing chamber 216. If the impulse of the pulsation is sufficient, the pulsation of the MHD force on the liquid metal 112′ in the firing chamber 208 can eject a corresponding droplet from the discharge region 212.

In certain implementations, the pulsed electric current “I” can be driven in a manner to control the shape of a droplet of the liquid metal 112′ exiting the nozzle 102. In particular, because the electric current “I” interacts with the magnetic field “M” according to the right-hand rule, a change in direction (polarity) of the electric current “I” across the firing chamber 216 can change the direction of the MHD force on the liquid metal 112′ along an axis extending between the inlet region 210 and the discharge region 212. Thus, for example, by reversing the polarity of the electric current “I” relative to the polarity associated with ejection of the liquid metal 112′, the electric current “I” can exert a pullback force on the liquid metal 112′ in the fluid chamber 208.

Each pulse can be shaped with a pre-charge that applies a small, pullback force (opposite the direction of ejection of the liquid metal 112′ from the discharge region 212) before creating an ejection drive signal to propel one or more droplets of the liquid metal 112′ from the nozzle 102. In response to this pre-charge, the liquid metal 112′ can be drawn up slightly with respect to the discharge region 212. Drawing the liquid metal 112′ slightly up toward the discharge orifice in this way can provide numerous advantageous, including providing a path in which a bolus of the liquid metal 112′ can accelerate for cleaner separation from the discharge orifice as the bolus of the liquid metal is expelled from the discharge orifice, resulting in a droplet with a more well-behaved (e.g., stable) shape during travel. Similarly, the retracting motion can effectively spring load a forward surface of the liquid metal 112′ by drawing against surface tension of the liquid metal 112′ along the discharge region 212. As the liquid metal 112′ is then subjected to an MHD force to eject the liquid metal 112′, the forces of surface tension can help to accelerate the liquid metal 112′ toward ejection from the discharge region 212.

Further, or instead, each pulse can be shaped to have a small pullback force following the end of the pulse. In such instances, because the pullback force is opposite a direction of travel of the liquid metal 112′ being ejected from the discharge region 212, the small pullback force following the end of the pulse can facilitate clean separation of the liquid metal 112′ along the discharge region 212 from an exiting droplet of the liquid metal 112′. Thus, in some implementations, the drive signal produced by the electrical power source 118 can include a wavelet with a pullback signal to pre-charge the liquid metal 112′, an ejection signal to expel a droplet of the liquid metal, and a pullback signal to separate an exiting droplet of the liquid metal 112′ from the liquid metal 112′ along the discharge region 212. Additionally, or alternatively, the drive signal produced by the electrical power source 118 can include one or more dwells between portions of each pulse.

As used herein, the term “liquid metal” shall be understood to include metals and metal alloys in liquid form and, additionally or alternatively, includes any fluid containing metals and metal alloys in liquid form, unless otherwise specified or made clear by the context. Metals suitable for use with the disclosure include aluminum and aluminum alloys, copper and copper alloys, silver and silver alloys, gold and gold alloys, platinum and platinum alloys, iron and iron alloys, and nickel and nickel alloys.

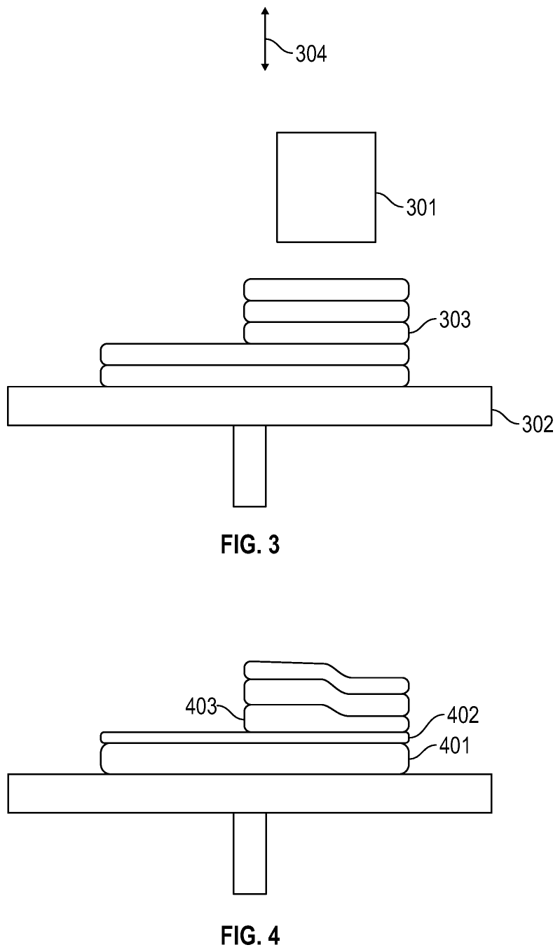

FIG. 3 depicts a side view of an additive manufacturing process, in which a nozzle 301 is moved relative to a build plate 302 while successive layers 303 of build material are deposited. For the purposes of this application, the Z-axis 304 should be understood to be perpendicular to the plane coincident with the build plate, and ideally parallel to the direction of gravity (the build plate being ideally level).

FIG. 4 depicts examples of errors that may occur during an additive manufacturing process. There may be uniform variation between layer heights, for instance between layers 401 and 402, which may accumulate in their amplitudes over the course of the deposition of successive layers. There may additionally be local variations 403 in the Z-axis height of layers, which subsequently disrupt the Z-axis profile of subsequent layers, even if those subsequent layers are of correct height. Finally, even if every layer is of consistent height, and all layers are the same height, if the layer height is incorrect the overall part will be ‘stretched’ or ‘compressed’ in the Z-direction. It is desirable to monitor such errors and provide preemptive or corrective measures.

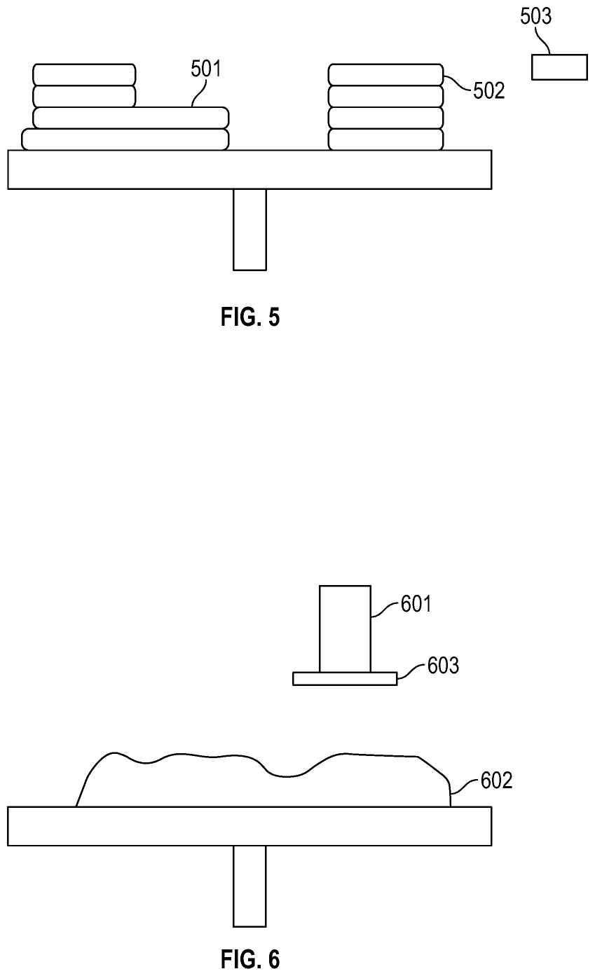

FIG. 5 depicts an embodiment in which a fiducial tower is manufactured alongside the part being manufactured. A part 501 is additively manufactured by deposition of successive layers at the same time as fiducial tower 502. Sensor 503 is used to determine the height of the fiducial tower. The fiducial tower is a relatively small, standard shape, for example a rectangular prism with a 5×10 mm footprint (i.e. viewed from above). Being a simple geometry in a known location, the fiducial is easily measured with low-cost means such as a beam-break proximity sensor. Since the geometry is simple and known, height errors specific to the geometry of the currently-printed part will not appear in the fiducial. Any error in the height of the fiducial can thus serve as an “average” error for ideal geometry, and the baseline for corrections which may be required.

FIG. 6 depicts an embodiment in which the surface of a part being manufactured is optically analyzed. A camera 601 views at least a portion of the part 602 through optical window 603.

In certain embodiments, the camera is equipped with auto-focus capability and is scanned across the part. The location of the camera relative to the build plate will be known mechanically by the robotic system, and therefore the focus distance reported by the camera can be used to determine the part height at the camera focus point.

In another embodiment, a low-cost camera with an optic having an intentionally-shallow depth-of-field is pointed downward at the top surface of the part. In one embodiment, computer-vision software is utilized to determine the amount of image blur and thus the distance of the surface from the ideal focus distance of the camera.

In another embodiment, a motorized adjustable-focus lens, again with shallow depth-of-field, on a low-cost camera as described above, is again aimed downward at the top surface of the part. With the part and camera stationary, the lens is programmatically swept through its focus range, and computer-vision software is used to identify the in-focus portions of the image at each focus point in the sweep. With a properly calibrated camera, each focus setting corresponds to a specific distance from the camera, and thus once again a map can be made which identifies the height of each area of the part. This method has the advantage that large portions of the top surface of a part can be evaluated without moving the camera, which greatly increases the speed of the process.

Alternative methods associated with this embodiment include identifying the focus point within the frame and scanning as with rangefinder or a camera with programmable focus point.

In another embodiment, a camera and optic, again with a shallow depth-of-field, are directed across the top surface of the part, at a slight downward angle (for example 1-5 degrees from horizontal), and the part illuminated with a strobe light during printing. Such a camera will produce a side view of the part at a specific distance from the lens, with the height of the in-focus area of the part proportional to the vertical position of the top layer in the camera's image. In one embodiment, this camera is also used to evaluate nozzle performance by tracking drop speed and angle, thus lowering the total cost of the printer on which it is installed.

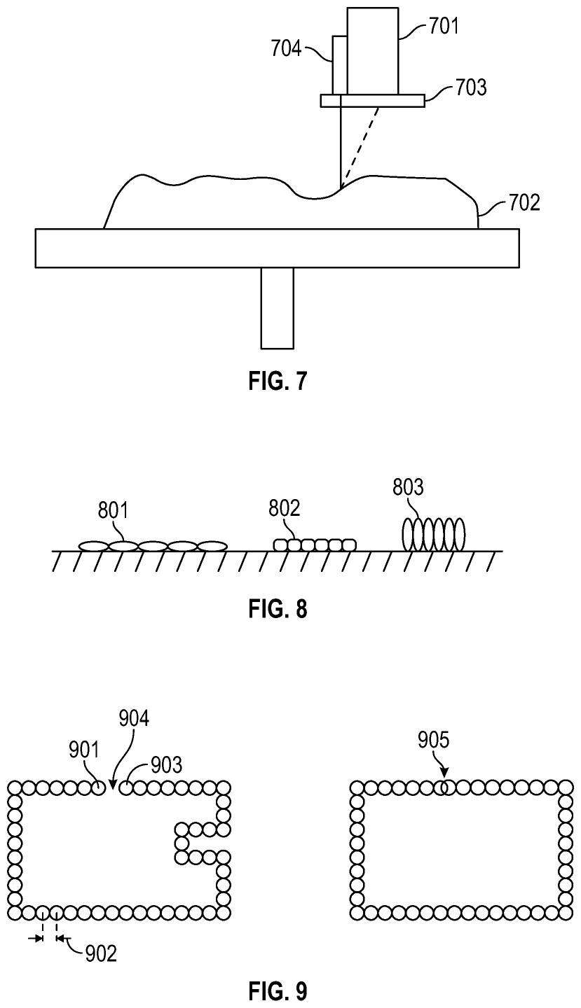

FIG. 7 depicts an embodiment in which the surface of a part being manufactured is analyzed via a laser 704. A rangefinder 701 (for example a laser rangefinder such as that available from Keyence, Inc. of Itasca, Ill.) is mounted in such a way that it can view the surface of the part 702 through an optional window 703. The part height of the area under the scanner is recorded as the scanner is passed over all or part of the top surface of the part. In one embodiment, this scanning is done as an operation separate from printing and the entire part scanned in an orderly fashion such as line-by-line (raster) scanning. In a preferred embodiment, the scanning is done during printing which has the advantage of increased time efficiency. The data for height of scanned areas is stored as an array of positions and corresponding heights (e.g. a 3D map) which can be referred to for corrective action. In one embodiment, only errors greater than a certain tolerance are addressed.

In another embodiment, only certain ‘high-risk’ areas of the part are scanned. ‘High-risk’ areas are those areas where past testing has shown that local height errors are likely to occur, such as sharp corners or small areas where only a small number of drops fit. In another embodiment, all areas are scanned, but ‘high-risk’ areas described above are scanned with a finer resolution than low-risk areas. In another embodiment, to save time, only the area of the part printed upon by the most recent layer is scanned.

In one embodiment, the printhead is made from electrically-conductive material and electrically isolated from the print bed, which is also electrically-conductive. An electric potential is applied between the printhead and print bed, and any current flowing between the two measured with a suitable current detector. Any current flow during printing indicates contact between a high spot on the part and the printhead, and gives an approximate position of the location. The exact position could be determined by one of the other methods.

FIG. 8 depicts the changing profile of deposited medium according to drop pitch. Drop pitch is the space between the center of successive droplets. For a given droplet size, a narrower (smaller) pitch produces a larger layer height. In area 801 a wide pitch produces relatively low height in the Z-axis. In area 802, a medium pitch produces a medium height in the Z-axis. In area 803, a small pitch produces a relatively large height in the Z-axis. Pitch and droplet size can be adjusted together or one at a time to adjust the heights of layers in the Z-axis. For example, if pitch is increased, droplet size may be increased to maintain consistent layer height.

FIGS. 9A-B depict problematic conditions that can occur during tool pathing with a fixed drop pitch. With reference to FIG. 9A, a first droplet 901 for a layer is deposited, followed by successive droplets at a pitch of 902, ending with last droplet 903. First droplet 901 and last droplet 903 should meet together similar to any of the other droplets in the layer to form a uniform height in the Z-axis. However, because of the particular shape of the layer, gap 904 is left between these droplets. This produces an uneven surface, which can affect the final surface finish or subsequent layers which may be deposited into gap 904. With reference to FIG. 9B, the particular shape of the layer results in two droplets overlapping at point 905, resulting in an error in which the height is too great. Both of these conditions are undesirable.

To solve the above types of errors, paths of arbitrary-length may be printed by slightly adjusting the drop pitch of a path such that the first and last drops land in the exact correct locations, such that the resultant path is exactly the desired length. This will create a small height error for that path, which can be compensated for in various ways described herein.

In one embodiment, the path length is divided by the drop pitch to yield the number of drops in the path. This number is then rounded up or down to the nearest integer number of drops, and a new drop pitch is calculated from the path length and integer number of drops.

For a given drop size, changing the drop pitch tends to affect the height and width of the resulting printed path, with the change in height being more pronounced. If the adjustment is made in the same direction (increase or decrease) over several layers, the small height error in each layer may “stack up” into an unacceptably-large height error over many layers. This may occur in only a portion of the printed shape, resulting in uneven part height in addition to overall height error. In a preferred embodiment, when the drop pitch of a certain path is adjusted in one direction (up or down), the resulting change in height is calculated, and an adjustment in the opposite direction is made to paths or portions of paths in layers printed later, thus tending to reduce or eliminate height error due to the drop pitch change. In one preferred embodiment, the adjustment is distributed across multiple layers in proportion to the amount of error introduced. For example if rounding down the drop pitch created a 0.5% error in one direction, and the rounding up created a 1% error in the other direction, two layers would be printed rounded down and one layer rounded up, causing the error to cancel.

In a preferred embodiment, adjustments to drop pitch described herein which create known height deviations are recorded in the same map described herein to store the results of scanning the top surface of the part. In another preferred embodiment, these data are combined with the scanning data to determine which corrections are required, to verify the scanning data, and to reduce the area of the top surface that must be scanned and thus the time taken to do the scanning.

In another preferred embodiment, the adjustment is made preferentially to portions of the path that are likely to have height errors for other reasons, such as presence or absence of surrounding drops, acute corners, or other geometric conditions. This tends to cancel the errors from multiple sources, resulting in less overall height error in the part. For example, acute corners tend to “bunch up” and create peaks, while overhangs tend to sag a little and create troughs. An acute corner on an overhang could have both. So in preprocessing, for every drop location, the expected effect of each factor in that location is summed to get a total expected error, then that error is compensated for by adjusting drop pitch to create the opposite effect. In cases where there is a need to tweak the pitch of a path, the tweaking preferentially done in the areas where correction is likely to be needed anyway, leaving “normal” areas at the original pitch.

In another embodiment, the profile of the top surface is scanned during printing, and the drop pitch adjustment is made preferentially to paths or portions of paths where the printed part is shorter or taller than desired, tending to counteract the height error over multiple layers.

In another embodiment, a corrected drop pitch is used as described above to place the first and last drops in the correct positions, but the drop size is also adjusted accordingly, thus minimizing or eliminating any change in printed layer height. For example, in a magnetohydrodynamic jetting head, the drop size might be adjusted by increasing or decreasing the ratio of negative pulse length to jetting pulse length, or increasing positive pulse width.

In another embodiment, the row pitch (in FFF parlance, ‘line spacing’) is changed in the opposite direction of the pitch, so the net height of the row remains the desired height.

In another embodiment, when linear infill is used, the angle of the infill is changes after every layer, thus randomizing the locations of height errors and reducing their cumulative effect, yielding less height error overall.

The length adjustment to a given path need never be more than 50% of one drop pitch, since larger adjustments could be achieved by adding or removing a drop from the path. It follows that printing with larger drops will tend to require larger length adjustments in absolute terms than printing with smaller drops.

For a fixed jetted drop diameter, there is a practical limit to the amount by which drop pitch can be changed without affecting print quality. If the pitch is reduced too much, the drops will no longer lay next to each other but will begin to stack vertically. If too large, the drops will not fuse to each other.

Now described is additional corrective action that may be taken to ameliorate or correct detected defects. In certain embodiments, when a global height error is detected, an undesired drop size change is inferred. In one embodiment, the jetting nozzle is automatically cleaned or otherwise serviced as a result of this detection. Should the error be due to drop size change, the cleaning routine will ostensibly return the drop size to the nominal value for that nozzle, and thus the layer height will return to nominal. This can be verified in the subsequent printed layer.

In another embodiment, global height error is compensated for by adjusting the planned height of subsequent layers of the part to match the new layer height measured on the part. This can be done for example by re-running the ‘slicing’ software known to the art on the remaining portion of the part to be printed, the measured de facto layer height being given as an input to the software instead of the prior nominal layer height.

In another embodiment, the horizontal spacing between printed lines is altered, again using slicing software. With a given drop size and drop pitch, a variation in horizontal line spacing will also affect layer height.

In a certain embodiments, global height error is compensated for by adjusting the spacing between jetted drops (i.e. drop pitch). For example, with drop size and distance between lines held constant, decreasing drop pitch will create taller lines. In another embodiment, height errors in a specific area of the part (local height errors), are corrected by altering the drop pitch only when drops are being deposited in the affected areas, resulting in taller or shorter vertical buildup of metal in that specific area. Note that this correction may be done in the slicing software, or as a post-processing operation, or ‘real time’ as printing is in progress.

In some embodiments, should low areas of sufficient depth be found, individual drops can be selectively jetted into these areas to raise their height to the nominal height. This can be especially useful if a drop fails to jet, leaving a ‘hole’ which can be filled by another drop.

In another embodiment, global or local height errors are corrected as described above, but by adjusting droplet size instead of droplet pitch. As in the preceding embodiment, the adjustment may be made as needed to an entire part or only a portion thereof.

In certain embodiments, after any correction is made, the part may be remeasured using any suitable means, and correction either increased, reversed, or eliminated as a result of the measured value found.

In certain embodiments, the part is measured at some multiple of layers, instead of at each layer.

The applicant has developed several techniques for the interpretation of FFF movement and extrusion commands from slicer software, conversion of those commands to suit the discrete deposition nature of drop-on-demand printing systems, and the programming of commercially-available motion controllers to deposit drops at the desired locations, in order to produce correct droplet placement and prevent height errors resulting from incorrect placement. The techniques are described below:

Use of Slicer Extrusion Commands

As described above, FFF slicer software automatically adjusts the volume of material extruded to account for various geometric conditions, such as overlapping paths. It is desirable to take advantage of these volume variations in drop-on-demand printing. However, the slicer software commands the extrusion in terms of millimeters of filament to be extruded by an FFF printhead, which has no direct relationship to where drops should be deposited.

The invention calculates the number of drops to be extruded as follows. First, the extrusion commands from the slicer are multiplied by the cross-sectional area of the filament as entered into the slicer software. This yields a volume of material to be deposited for a given path. In one embodiment, a filament diameter having a 1 mm² cross-sectional area is entered into the slicer software, so that each millimeter of filament commanded by the slicer software can be interpreted as 1 mm³ of material volume to be deposited. This yields a volume of material for any given path. Next, this total volume is divided by the volume of a single jetted droplet, to yield the total number of drops to be jetted for that path (taking into account any variations along the path commanded by the slicer).

Accounting for “Partial Drops”

In the technique described above, the drop pitch is modified so a path of any length is filled by an integer number of drops. However, if a path consists of multiple segments—as is the case for any path not consisting of a single straight line—there is no guarantee that each individual segment will require enough material for a drop to be ejected. In a finely-tesselated model, tens or even hundreds of short segments might be used to create a tightly-curved area of the model. Some or all of these segments might only require an amount of material that is a fraction of that deposited with one drop of molten metal from a given nozzle. A naïve approach—ignoring any segments which don't require at least one drop's worth of material—could end up omitting large portions of a path. Attempting to round the volume up or down could likewise result in drops being deposited unevenly along the path, resulting in varying drop pitch and resultant height differences as described above.

The solution proposed is to track the volume requested by the slicer for each segment printed, and deposit drops at the appropriate positions along the path regardless of the number or length of segments or the locations of the segment start and end points.

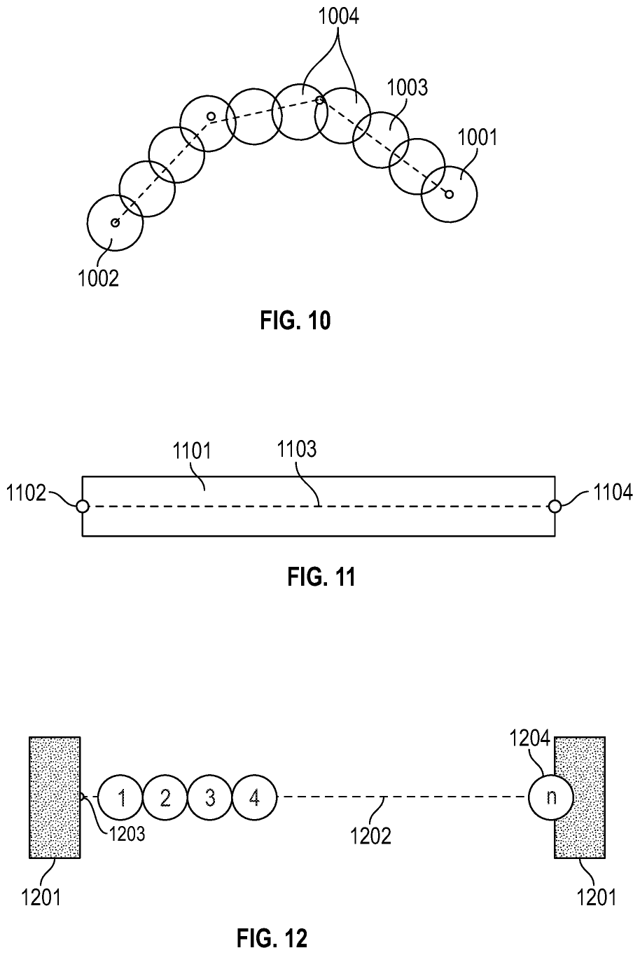

Many motion controllers require each segment of multi-segment motion to be commanded with integer numbers of ‘counts’ to define the movement of each axis, counts being known by those skilled in the art to refer to quadrature encoder counts for servomotor-based motion systems, or steps (or microsteps) for step-motor based motion systems. In one embodiment, drop deposition is controlled by the output of one motion axis of such a motion controller (as described herein), while X, Y, and Z motions are controlled by other motion axes. Instead of attempting to have each count represent a single drop (which would require an integer number of drops for every segment, leading to the errors described above), each count is defined to represent a smaller volume of material, for example 1/1000 of a drop's volume. The jetting mechanism is likewise designed to deposit one drop for every corresponding number of counts (1000 in this example). In this way, each segment can be sent to the motion controller with a number of jetting counts equal to the volume of material required for that segment, divided by the volume of a single drop, multiplied by (in this example) 1000. Rounding this number to an integer results in a maximum volume error of 1/2000 of a drop volume for each segment. As segments are executed by the controller, the counts are sent to the jetting mechanism which deposits a drop every (in this example) 1000 counts it receives, without regard how many segments have been executed or where in the segment the printhead may be. The drops are thus correctly spaced in all circumstances and for any segment length. Reference FIG. 10 and description elsewhere in this document.

Flight Time Compensation

To compensate for the time that elapses between a drop ejection command, and the landing of the drop (described above), several techniques are disclosed.

Since the error is of constant time, regardless of speed of head/table movement, in a preferred embodiment a time delay is added to the motion components of the path, while the droplet commands are not delayed. In one embodiment, the firmware of the motion controller is programmed to introduce this delay. In another embodiment, the motion controller is programmed to output step and direction signals to the motor drivers, and an electronic circuit such as an FPGA (Field Programmable Gate Array) is inserted between the controller and drivers. The FPGA is programmed to introduce the required delay to the step & direction signals, in effect delaying the motions by a constant time.

In another embodiment, the motion path including velocities is calculated outside the motion controller, and the delay at each point is translated into a distance and direction. The commands for movement are then “shifted” relative to the commands for drops, by the amount of the delay at each point.

Within Slicer Software or as External Program

Because many slicer software programs are distributed with ‘open-source’ licenses, they can be freely modified by the end user. It should be understood that the calculations described above can be thus integrated into the slicer software by modifying it.

However, once this is done, it becomes more difficult to apply software updates from other users since the modifications must be merged and re-tested with the new updates. Therefore, the calculations can also be implemented as a separate program, without fundamentally changing the invention.

Generation of Drop Triggers Via Additional Motion Axis

In drop-on-demand printing in general, and in MHD printing in particular, drops are ejected by brief, high-current pulses. These pulses are in turn generated by a circuit which is triggered by an externally-generated low-current pulse, such as a TTL (time-to-live) pulse. While most commercial motion controllers can produce TTL pulses though so-called digital outputs, these outputs are not usually well-synchronized with complex multi-axis motion to the extent required for accurate droplet placement.

The technique disclosed generates these pulses accurately by using an additional motion axis configured for step/direction output. The motion controller will control motors for the X, Y, and (optionally) Z axes of the mechanical motion system, and in addition will issue step pulses as a fourth ‘axis’, synchronized with the others. While the motion controller is configured as if it were controlling four motors, it is in fact controlling three motors and generating pulses for droplet jetting. By commanding, for example, a linear interpolated move including commands for a fourth axis, drops will be ejected in synchrony with the motion of the head or table.

Because it generally operates on pre-tessellated 3D models (such as STL files), slicer software will output paths which are a series of straight lines. Curved areas are approximated by many short lines. A path consisting of a single linear segment is defined by two coordinates, and additional segments are represented by one additional coordinate each. The printer simply “connects the dots” to generate the desired path. In the current invention, once the desired drop pitch is calculated, an additional parameter for each point is added to represent the number of drops to be ejected for that segment. Therefore it is not necessary to give a command for the position of each droplet along the path—the required number of drops is automatically placed by the motion controller evenly along the segment.

Should a variation in pitch within a segment be required, there is an insertion of additional points as needed to define ‘sub-segments’, each which can have associated with it a certain number of drops and thus any drop pitch. Since the number of such drop-pitch changes within a given path is generally much smaller than the number of drops in the path, this method is far more efficient than defining the position of each droplet, while still allowing the required control of the drop pitch anywhere along the path.

Beyond the discrete nature of drop deposition, other differences between drop-deposition exist and must be accounted for. FFF slicers assume that when a line of material is deposited, the physical boundary of the deposited material begins at the start point of the path, and ends at the endpoint. FIG. 11 depicts a top view of a theoretical FFF deposition showing this effect. The material 1101 is deposited to the left and right of the path 1103, but does not overlap the start point 1102 and end point 1104 in the direction of travel.

By contrast, in droplet printing, a deposited droplet extends past the nozzle center position in every direction by the radius of the droplet, meaning that printed material ‘overhangs’ the start and end point by that amount. For example, to add a line of material that fills the space between two existing walls, the FFF slicer would command a move that begins on the edge of one wall and ends on the other.

FIG. 12 depicts a linear path where drops are deposited without manipulation along a path 1202 between two previously-printed walls 1201. The slicer places endpoints 1203 and 1204 directly on the edges of the walls, as described above. The printer deposits a droplet whenever the head moves by an amount equal to one drop pitch. As a result, there is a gap between the first drop deposited 1 and the wall at the start point 1201, the gap size being ½ the drop pitch. Meanwhile, the last drop n is deposited partially overlapping the wall at the endpoint 1204. The invention offsets the drop positions along the path by one-half of the drop pitch, such that the edge of the first drop of a path lands at the start point 1203, and the edge of the last drop deposited lands on the end point of the path 1204. This prevents the gap and overlap described above.

In one embodiment, where a motion axis is used to control drop deposition, the offset required is implemented by advancing said motion axis by half the number of counts required to trigger a droplet deposit, before the toolpath is executed. When the toolpath is executed, the jetting axis needs only move half the number of counts before a drop is deposited; this has the effect of moving the first drop and all subsequent drops earlier in the path by ½ drop pitch, eliminating both the gap at the start and the overlap and the end of the path.

Another difference between extruded and drop-based deposition is the non-contact nature of jetting, and the resulting effects of self-intersecting paths. In extrusion-based printing, the nozzle is in contact with the printed part. This has the effect of allowing excess material to flow slightly, in order to fill small gaps or imperfections. In metal drop-on-demand printing, a small gap between part and printhead must be provided to allow droplet formation and prevent the cooler part from freezing the molten metal within the nozzle. While a certain amount of flow will occur due to local melting with each incoming drop, this is not physically enforced as it is with FFF printing.

One consequence of this is apparent in curved portions of paths and corners. For a curved path of finite width, the portion of the curve closer to the center will have a smaller radius and thus a smaller volume than that portion further from the center. In a sharp corner, the path overlaps itself inside the corner, and there is a (theoretical) gap in the outside corner.

An extruding-type printhead which extrudes the nominal amount of material and contacts the part being printed can partially compensate for this effect because the excess material in the inside of the corner can be forced to flow to the outside. In droplet-based printing, this effect is partially replicated by the melting effects described above, but without contact the movement of material cannot be enforced, and buildup is possible. As in other cases, this buildup causes height errors.

When printing an arbitrary path as described above, there is no particular position where drops will be placed along a path. In the case of a sharp corner, drops will most likely be placed immediately before the corner and immediately after it, instead of directly on the corner. For Depending on the angle of the corner (and with a severity in inverse proportion to that angle), the printed drops will tend to “cut the corner” and overlap partially, causing a buildup of material in the corner. By contrast, if a droplet is placed directly on the corner, then for all angles greater than 60° (theoretically, in practice smaller), there will be no drop overlap and no resultant height errors. Thus the invention uses a similar mechanism as described above for fitting an integer number of drops to an arbitrary-length path, to intentionally place drops at sharp corners by slightly adjust drop pitch in the various segments of a path.

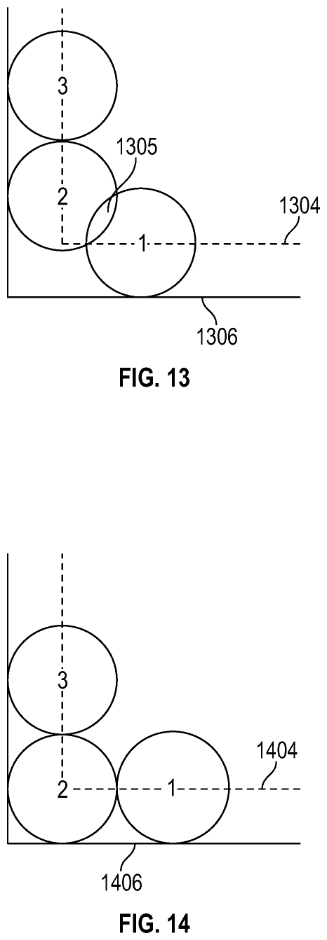

FIG. 13 depicts drops 1, 2, 3 jetted along a path 1304 to create an outer edge 1305. In this case, no drop is placed at the corner, causing an overlap 1305. FIG. 14 depicts the effects of drops placed with the same spacing along the path 1404, but where drop placement has been manipulated such that drop 2 is placed with its center directly on the corner. Note that there is no overlap in this case.

An alternative approach to using either a grid-based raster or FFF-based vector toolpaths is that of “semi-rastering”. In this approach, outlines of parts are not printed. Instead, the desired print area for a given layer is divided into “stripes” or lines of either constant or varying width. Unlike a raster, there is no fixed grid—the slicer is programmed to fill the printed area with lines in whatever location is required to optimize the filling of the printed area for a given layer. In one embodiment, the slicer is programmed to choose a line width which optimally fills the area. In an alternative embodiment, the slicer uses varying line widths to optimally fill the area. Similarly, the slicer can be programmed to produce only lines whose lengths are integer multiples of the nominal drop-pitch. Again unlike a grid-based raster, the start and end points can be placed arbitrarily to optimally fill the desired area, while retaining the length requirement. This provides the best height consistency, but increases inaccuracy in the edges of parts. In an alternate embodiment, the slicer can be allowed to generate lines of any width, which reduces this inaccuracy. In that case, the pitch-adjustment technique described can be used to print this lines, with the resulting height error which must be compensated for by other means. In a preferred embodiment, the slicer varies both line width and drop pitch to create an optimal fill pattern which retains maximum edge fidelity while also maintaining accurate and consistent layer heights.

What is claimed:

1. A method for accommodating tool path length during additive manufacturing, comprising the steps of:
determining a tool path length for a layer of build material to be deposited;
dividing the tool path length by a drop pitch to determine a droplet count;
rounding the droplet count to an integer;
determining an updated drop pitch according to the integer; and
depositing the layer of build material using the updated drop pitch.

2. The method of claim 1 wherein the droplet count is rounded to the nearest integer.

3. The method of claim 2 further comprising rounding a second droplet count in the opposite direction of the droplet count to determine a second integer.

4. A method for adjusting a Z-axis height of layers during additive manufacturing, comprising the steps of:
depositing a first layer of a build material at a first droplet pitch;
profiling the first layer to identify at least one Z-axis height defect in the first layer;
depositing at least a portion of a second layer of the build material at a second droplet pitch to correct the Z-axis height defect.

5. The method of claim 4 wherein the step of profiling the first layer includes scanning a top surface of the first layer using a laser point scanner.

6. The method of claim 4 wherein the step of profiling the first layer includes scanning a top surface of the first layer using a laser line scanner.

7. The method of claim 4 wherein the step of profiling the first layer includes scanning a top surface of the first layer using a camera.

8. The method of claim 7 wherein the camera is autofocused and is mechanically scanned across the first layer.

9. The method of claim 7 wherein the camera has a fixed focus and computer vision software is used to determine the distance between the camera and the top surface of the first layer according to a degree of blur.

10. The method of claim 9 wherein the camera has a shallow depth-of-field, and is programmatically swept through its focus range while the camera is maintained stationary with respect to the first layer.

11. The method of claim 4, further comprising the step of adjusting a droplet size to aid in correcting the Z-axis height defect.

12. A system configured to adjust a Z-axis height of layers during additive manufacturing, comprising:
a nozzle configured to deposit a first layer of a build material at a first droplet pitch;
a monitoring system configure to identify at least one Z-axis height defect in the first layer; and
wherein the nozzle is configured to deposit at least a second layer of the build material at a second droplet pitch to correct the Z-axis height defect.

13. The system of claim 12 wherein the monitoring system is configured to scan a top surface of the first layer using a laser point scanner.

14. The system of claim 13 wherein the monitoring system is configured to scan a top surface of the first layer using a laser line scanner.

15. The system of claim 12 wherein the monitoring system is configured to scan a top surface of the first layer using a camera.

16. The system of claim 15 wherein the monitoring system includes a camera that is autofocused and configured to be mechanically scanned across the first layer.

17. The system of claim 15 wherein the monitoring system includes a camera that includes a fixed focus.

18. The system of claim 15 wherein the monitoring system includes a camera that has a shallow depth-of-field and configured to be programmatically swept through its focus range while the camera is maintained stationary with respect to the first layer.

19. The system of claim 11, wherein the nozzle is configured to adjust a droplet size to aid in correcting the Z-axis height defect.
